(19) United States
(12) Patent Application Publication
(10) Pub. No.: US 2008/0276671 A1
(43) Pub. Date: Nov. 13, 2008

(54) Locking box for valuables

(75) Inventor: Chien-Chih Lu, Kaohsiung County (TW)

Correspondence Address: Joe McKinney Muncy, PO Box 1364, Fairfax, VA, 22038-1364, US

(73) Assignee: MIZ ENGINEERING LTD.

(21) Appl. No.: 11/798,158

(22) Filed: May 10, 2007

(51) Int. Cl. E05B 53/00

(52) U.S. Cl. 70/263

(57) ABSTRACT

A locking box for valuables includes a wire winding box, a winding control assembly and a lock. The wire winding box has a fastening seat at a lower end that includes an upper fastening disk and a lower fastening disk. The winding control assembly is hinged on the wire winding box and includes a wire wheel, an elastic element and a holding board. The elastic element is held on an eccentric shaft of the holding board and hinged on one end of the wire wheel. The lock can be held inside or outside the wire winding box and has a screw at one end to couple or disengage with a detection terminal of the wire winding box and a connection bar at another end to fasten to a threading wire which chain locks valuables and is latched on or disengaged with a lock plug.

### FIELD OF THE INVENTION

The present invention relates to a locking box for valuables and particularly to a locking box which is mountable onto a counter or table and equipped with a lock to chain valuables to facilitate viewing and wearing and also has a wire wheel to control retraction and releasing of the lock.

### BACKGROUND OF THE INVENTION

Conventional jewel locks now on the market generally include a steel chain, a lock and the like. The lock has a connection bar at one end to facilitate fastening of a jewel lock that holds valuables such as jewelries, diamonds, brand name watches and the like to a counter or table by encircling. Thereby the lock can safely latch the desired articles. Such a lock also is widely used in people's daily life and becomes an indispensable household article.

The conventional jewel locks mentioned above accomplish locking by encircling the steel chain over the periphery of the counter or table. The steel chain has connection bars at two ends positioned in a juxtaposed manner to be coupled with a lock. No other function is provided. There are still problems for a jewel lock in practical use, notably:

1. When a conventional jewel lock is in use, the lock is exposed and fastens two ends of a steel chain which encircles the periphery of a counter or table. When customers want to see valuables such as jewelries, diamonds, brand name watches or the like, store staffs fetch the articles requested by the customers and place them on the counter or table to be perused or trial-fitted by the customers. After the customers have made selections, the valuables are returned to the guarded display location. However during perusing or trial fitting pilferage could occur caused by ill intention persons. The conventional jewel lock does not provide adequate theft-preventing function.

2. When the owner or shop keeper is not constantly presented at the display counter or table, or does not pay full attention to the valuables such as jewelries, diamonds, brand name watches or the like while the valuables are not being locked securely, as the conventional jewel lock cannot chain-lock the valuables, those valuables not being locked but displayed on the counter or table could be stolen. It could cause a great loss to the owner or shop keeper.

### SUMMARY OF THE INVENTION

The primary object of the present invention is to provide a locking box for valuables that can be attached or fastened to a display counter or table and chain-lock the valuables such as jewelries, diamonds, brand name watches or the like. It has a winding control assembly which has an elastic element in cooperation with a pin to control wire retraction and releasing of a wire wheel to facilitate viewing and trial fitting. The wire wheel also can control retraction and releasing of a lock.

To achieve the foregoing object, the locking box of the invention includes at least a wire winding box, a winding control assembly and a lock. The wire winding box has a fastening seat at a lower end that includes an upper fastening disk and a lower fastening disk, a frame at an upper end that has a sliding door and an upper lid. The fastening seat has a directing trough on the periphery of an upper end to be wedged by the frame and a bulging surface that has an opening in the center. There are a wedge trough and an arched notch formed between the directing trough and the bulging surface. The fastening seat also has a lower end with a housing space to hold the upper fastening disk and a plurality of sunken holes formed thereon. The winding control assembly is hinged in the wire winding box and includes a wire wheel, an elastic element and a holding board. The wire wheel has a bottom end with a holding trough formed thereon, a wheel seat with a boss at an upper end and a sealing cap. The elastic element is held in the holding trough. A wire reel is provided and wound on the boss of the wheel seat and has with a detection terminal located at one end. The sealing cap is fastened to the boss of the wheel seat to prevent the wire reel from escaping. The holding board is wedged in the fastening seat to hold the winding control assembly. The lock may be retracted and held in the wire winding box with an opening formed at one end running through by the detection terminal and screwing with a screwing element, and a threading wire at other end to chain-lock the valuables and a connection bar to be latched on or escape a lock core of the lock.

By means of the construction set forth above the following main functions can be achieved: when the lock is used to chain-lock the valuables, the elastic element in the winding control assembly, in cooperation with the pin, can be extended or retracted to control retraction or releasing of the wire reel wound on the wire wheel, and drive synchronously the wire reel on the boss of the wire wheel to control retraction and releasing of the lock. Thus users know clearly the use condition of the lock which has chain locked the valuables to control retraction and releasing of the lock. As a result desired safety can be achieved, Moreover, the frame and the fastening seat of the locking box are coupled together and can be rotated for 360 degrees. Installation is more flexible without creating positioning hindrance. Thereby viewing and trial fitting are more convenient.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is another exploded view the invention.

FIG. 3 is an exploded view of the locking box for valuables and a lower fastening disk.

FIG. 4 is a schematic view of an upper fastening disk and a lower fastening disk in a turning and latching condition.

FIG. 5 is a perspective view of the invention mounted onto a table.

FIG. 6 is a schematic view of the invention showing a wire wheel and a holding board in a coupling condition, partly cut away.

FIG. 7 is a schematic view of the invention showing the threading wire of the lock chain-lock valuables.

FIG. 8 is a bottom view of the invention showing a wire reel being pulled out to turn a wire wheel at the same time.

FIG. 9 is a schematic view of the invention showing a pin being latched in an 1-shaped groove.

FIG. 10 is a schematic view of the invention showing the pin being latched at a latch end.

FIG. 11 is a schematic view of the invention showing the pin being latched in a middle portion of a 7-shaped groove.

FIG. 12 is a schematic view of the invention showing the pin being latched at a front end of the 7-shaped groove.

FIG. 13 is a bottom view of the invention showing the wire reel in a retracting condition to turn the wire wheel in the opposite direction at the same time.

FIG. 14 is a perspective view of the invention showing the lock being retracted in the wire winding box.

### DETAILED DESCRIPTION OF THE PREFERRED EMBODIMENT

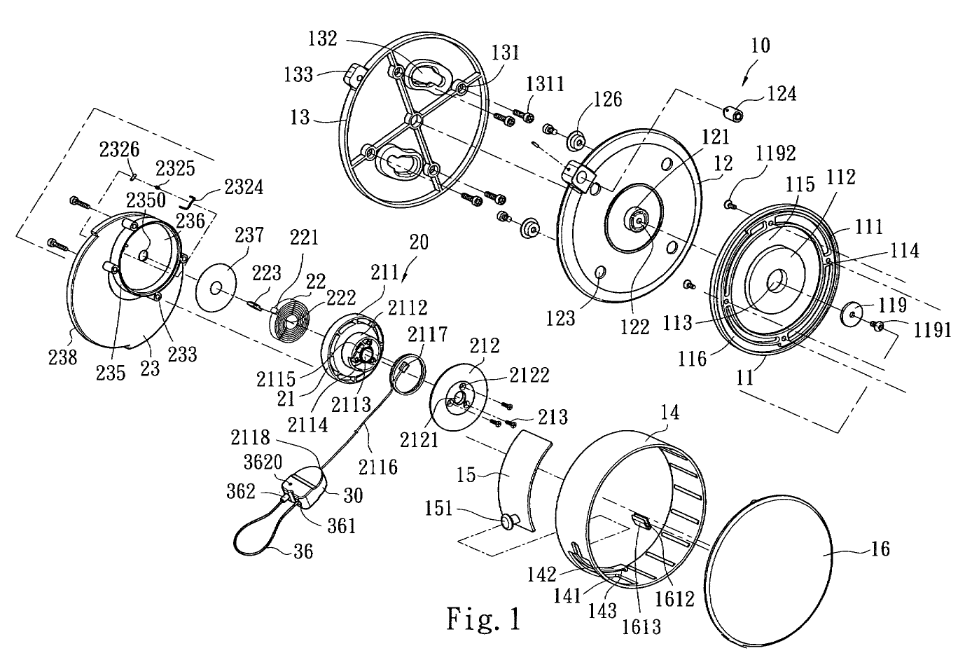

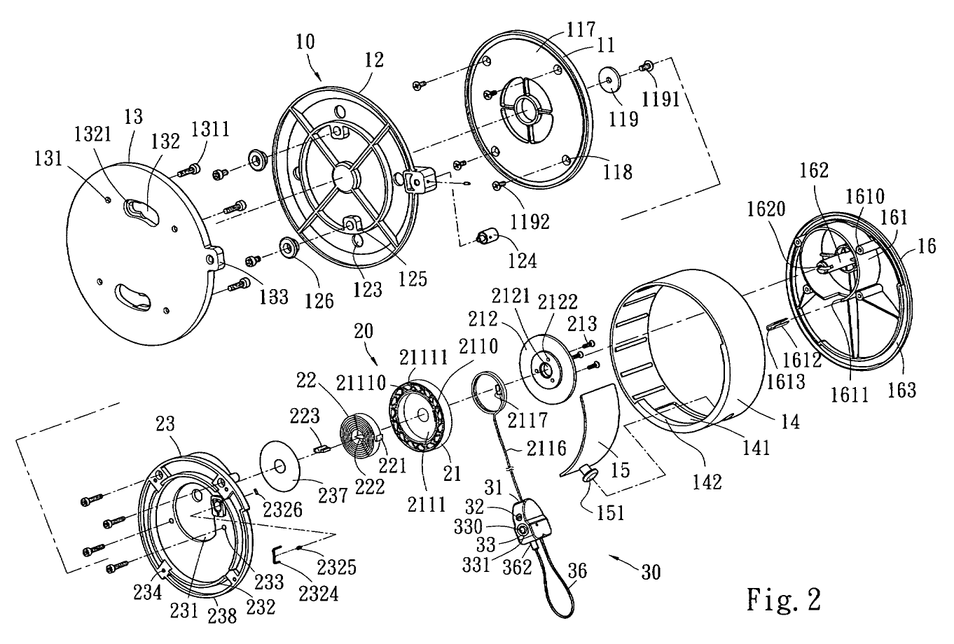

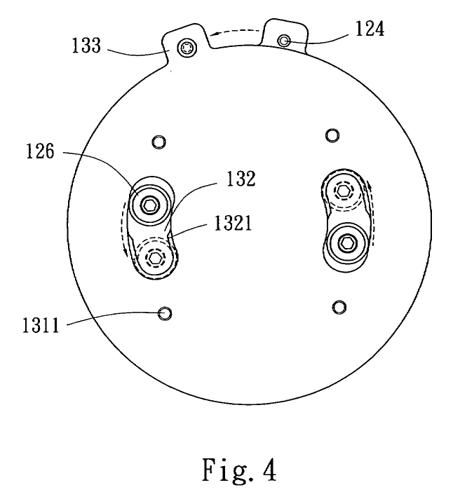

Please refer to FIGS. 1 through 4 and 6, the invention includes at least a wire winding box 10, a winding control assembly 20 and a lock 30.

The wire winding box 10 has a fastening seat 11 at a lower end that includes an upper fastening disk 12 and a lower fastening disk 13, and a frame 14 at an upper end that has a sliding door 15 and an upper lid 16. The fastening seat 11 has an outer directing trough 111 on the periphery at an upper end to be wedged in by the frame 14 and a bulging surface 112 which has an opening 113 in the center. Between the outer directing through 111 and the bulging surface 112, there are a wedge trough 114, an inner directing trough 115 and an-arched notch 116. The fastening seat 11 also has a housing space 117 at a lower end to hold the upper fastening disk 12 and a plurality of sunken holes 118 formed thereon. The upper fastening disk 12 is held in the housing space 117 and has a strut 121 in the center of the upper end thereof facing the opening 113. The strut 121 has a screw hole 122 at an upper side. The fastening seat 11 and the upper fastening disk 12 are coupled through a fastening plate 119 and a fastening element 1191. The upper fastening disk further has a plurality of apertures 123 close to the periphery corresponding to the sunken holes 118, a lock element 124 on the periphery, and a latch hole 125 at a lower end thereof to be fastened by a fastening member 126. The lower fastening disk 13 has a plurality of fastening holes 131 at a upper end to be screwed by fastening elements 1311, and a slot 132 corresponding to the latch hole 125. The slot 132 has a latch flange 1321 at one end and a latch lug 133 on the periphery corresponding to the lock element 124 such that the fastening member 126 can be held in the slot 132 to be latched. The lower fastening disk has a lower end to be fastened to a table 40 by screwing or bonding. The upper lid 16 has a lower end with one side extending downwards to form a frame 161 which has a plurality of screw holes 1610 on the periphery. The frame 161 has a notch 1611 at one side to be coupled by a latch body 1613 of a latch trough 1612, and a shaft 162 which has a latch slot 1620 formed in the center of a distal end, and an arched trough 163 at the edge of a lower end.

The winding control assembly 20 is hinged on an inner side of the winding box 10, and includes at least a wire wheel 21, an elastic element 22 and a holding board 23. The wire wheel 21 has a wheel seat 211 which has a latch trough 2110 at a bottom end and a holding trough 2111 which has an inner annular groove 21110 and an outer annular groove 21111. The inner and outer annular grooves 21110 and 21111 are interposed by 1-shaped grooves 2112A and 7-shaped grooves 2113A that are formed alternately relative to each other. The wire seat 211 also has a boss 2112 at an upper end which has a through hole 2113 running through the holding trough 2111 and a plurality of screw holes 2114 on the periphery, and also a notch 2115 at one edge to be latched by a hook end 2117 formed at one end of a wire reel 2116 and a sealing cap 212 which has an opening 2121 and apertures 2122 on the periphery. The sealing cap 212 may be fastened through fastening screws 213 and the apertures 2122 of the sealing cap 212 to the screw holes 2114 at the boss 2112 of the wheel seat 211. The elastic element 22 such as a spring has an extensible elastic force and is held in the holding trough 2111 of the wire wheel 21, and has a latch member 221 at one end running through the latch trough 2110 to be latched and anchored in the holding trough 2111, and other end 222 inserting into the latch slot 1620 of the shaft 162, and coupled by a coupling member 223 to prevent the elastic element 22 from escaping. The holding board 23 is located on an upper side of the fastening seat 11 and has an eccentric holding trough 231 at a lower end to hold the fastening element 1191 that fastens the fastening seat 11 and the upper fastening disk 12, and also an annular wedge member 232 held in the inner directing trough 115 of the fastening seat 11. The annular wedge member 232 has a coupling element 2321 close to one side that has a conical cavity 2322 in the center and a corresponding through hole 2323 and a slot 2323a to hold a pin 2324. The pin 2324 is coupled with a spring 2325 in the center and is pressed by a pressing bar 2326 at the bottom end of the conical cavity 2322 so that one end of the pin 2324 is held in the through hole 2323 and other end is turnable repeatedly in the slot 2323a through the return force of the spring 2325. The eccentric holding trough 231 has fastening holes 233 on the periphery corresponding to the frame 161 of upper lid 16 and fastening holes 234 corresponding to the sunken holes 118 of the fastening seat 11 for fastening, and an eccentric frame 235 at an upper end with a center hole 2350 formed thereon. The eccentric frame 235 has a holding trough 236 which holds a plastic blade 237 to reduce friction when in contact with the elastic element 22 at the bottom end of the wire wheel 21. The holding board 23 also has an arched groove 238 on the periphery to be wedged by an arched edge 142 formed on an inner side of the frame 14.

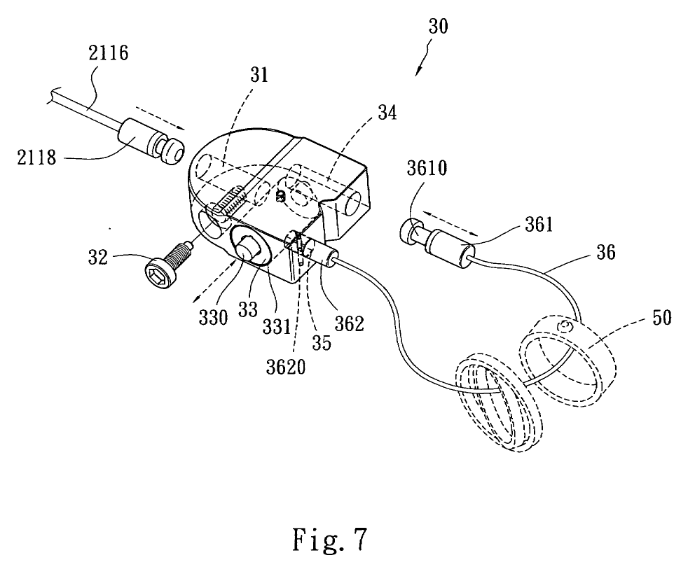

The lock 30 may be retracted in the hollow frame 14 and has an opening 31 at one end to receive a detection terminal 2118 at other end of the wire reel 2116. The opening 31 receives a screw 32 to fasten the detection terminal 2118 and a core cavity 331 at one side to hold a lock core 33, and a first and a second fastening holes 34 and 35 at another end to receive a connection bar 361 and a fastening end 362 fastened to two ends of a threading wire 36. The connection bar 361 has a latch groove 3610 and can be inserted into the first fastening hole 34 to latch the lock core 33 (referring to FIG. 7). The core 33 has a plug 330 which may be actuated to disengage the connection bar 361 and the lock core 33 to allow the connection bar 361 to be pulled out. The fastening end 362 is inserted into the second fastening hole 35 to be latched at other end of the lock 30 through a fastening pin 3620.

The 1-shaped groove 2112A at the bottom of the wheel seat 211 has a latch end 2112a bent from an inner side and inclined gradually from a lower elevation to a higher elevation, and inclined again gradually from the latch end 2112a to form another latch end 2112b with the outer annular groove 21111. The neighboring 7-shaped groove 2113A has a middle portion 2113a and inclines gradually therefrom to a front end 2113b and a rear end 2113c at two sides. The rear end 2113c communicates with the outer annular groove 21111.

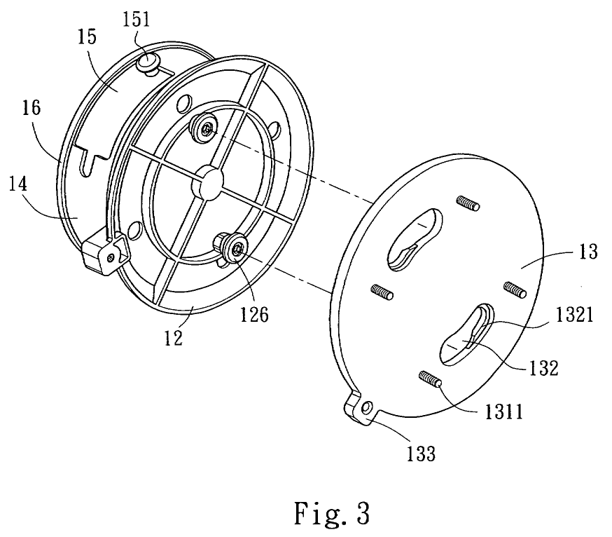

Referring to FIGS. 3, 4, 5 and 6, the upper and lower fastening disks 12 and 13 of the wire winding box 10 are coupled with the slot 132 through the fastening member 126, and after having been latched on the bottom of the latch flange 1321, they are aligned and positioned through the lock element 124 and the latch lug 133. Fasten fastening elements 1192 to the sunken holes 118 and fastening holes 234 to couple the fastening seat 11 and the holding board 23 together. Fasten the fastening plate 119 through the fastening element 1191 to the screw hole 122 of the strut 121 of the upper fastening disk 12; wedge the annular wedge member 232 at the lower end of the holding board 23 in the inner directing trough 115 of the fastening seat 11; align the arched groove 238 with the arched notch 116 of the fastening seat 11; in the holding trough 236 at the upper end of the holding board 23, and in cooperation with the winding control assembly 20, insert the pin 2324 into the through hole 2323 and slot 2323a of the holding board 23; dispose the spring 2325 in the center and press the spring with the pressing bar 2326 to the bottom end of the conical cavity 2322 so that one end of the pin 2324 is held in the through hole 2323 while other end is turnable in the slot 2323a. In response to pulling and turning of the wire reel 2116, the pin 2324 is moved to the 1-shaped groove 2112A or 7-shaped groove 2113A to form a latched or turning condition. Wedge the arched edge 142 of the frame 14 in the arched groove 238 on the periphery of the holding plate 23; insert the shaft 162 at the lower end of the upper lid 16 into the through hole 2113 of the wire wheel 21; with the other end 222 of the elastic element 22 inserted in the latch slot 1620 of the shaft 162, and the shaft 162 also is inserted through the plastic blade 237 and holding board 23 into the center hole 2350 of the eccentric frame 235. The arched trough 163 at the lower side of the upper lid 16 is coupled with the sliding door 15 held in the arched directing trough 143 of the frame 14 to form the locking box for holding valuables 50.

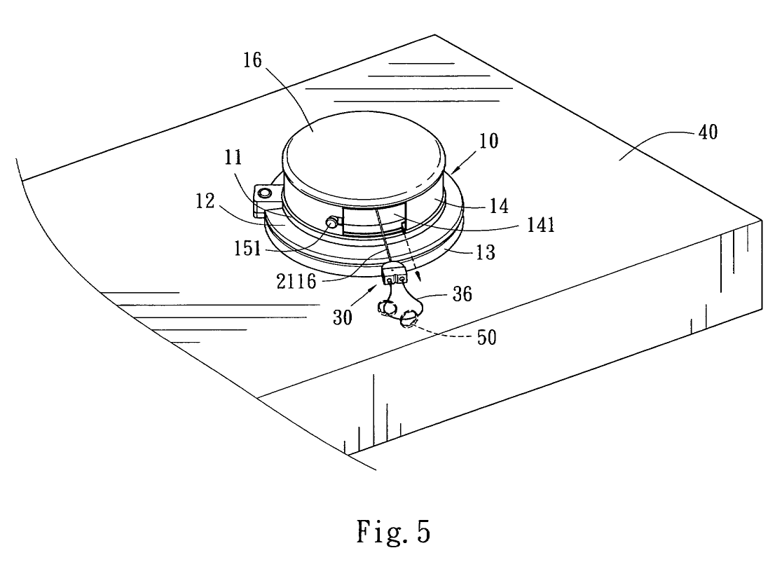

When in use, referring to FIGS. 5, 6 and 7, the lower fastening disk 13 at the bottom of the wire winding box 10 is bonded to the display counter or table 40 (or through the fastening elements 1311 running through the fastening holes 131). The sliding door 15 may be opened by a user's hand by grasping and moving a handle 151 on the sliding door 15. The plug 330 of the lock 30 may be actuated to separate the connection bar 361 from the plug 330. The valuables 50 such as jewelries, diamonds, brand name watches and the like to be perused or for trial fitting by customers may be chain locked on the threading wire 36 at one end of the connection bar 361. Then insert the connection bar 361 into the first fastening hole 34 of the lock 30 and push the plug 330 to latch the connection bar 361. Then the valuables 50 may be seen by customers. In the event that the customers are at a distance from the counter or table 40, one end of the lock 30 may be connected to the detection terminal 2118 at other end of the wire reel 2116 latched on the boss 2112 of the wheel seat 211 to allows the lock 30 to be gradually pulled out and positioned at a desired location on the display counter or table 40.

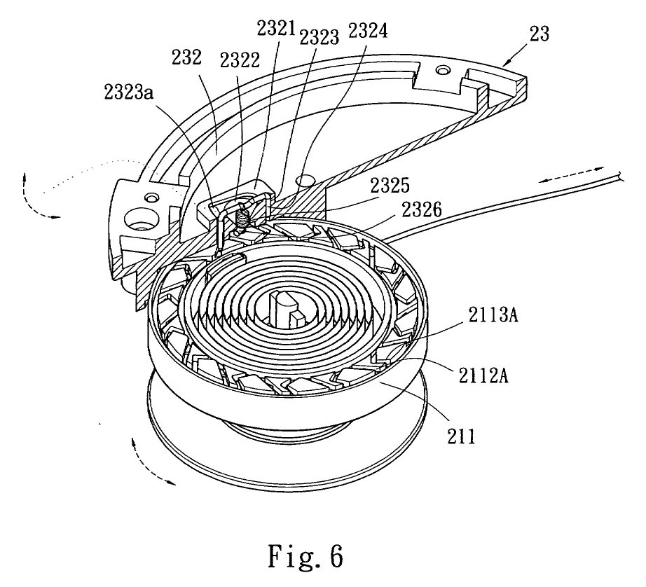

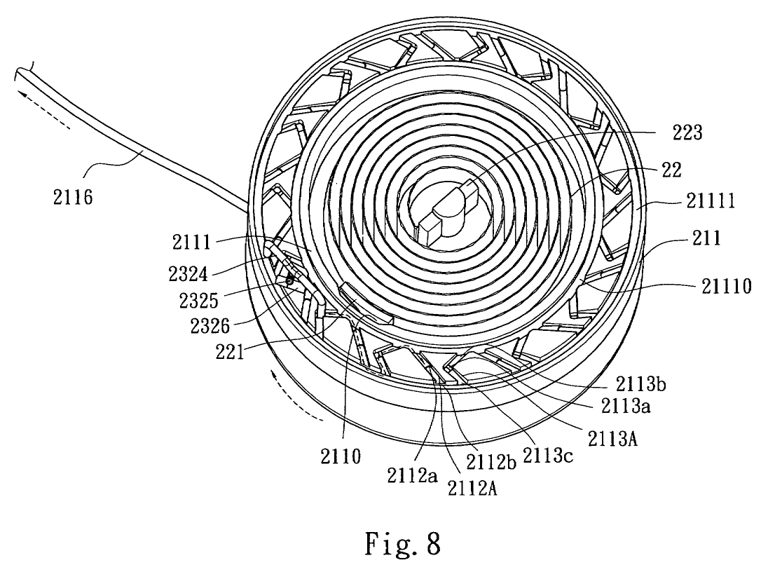

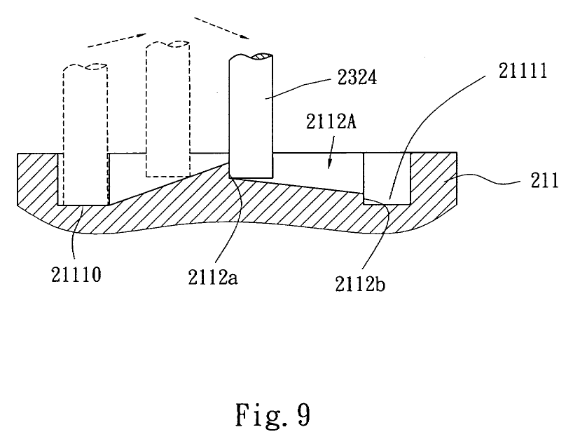

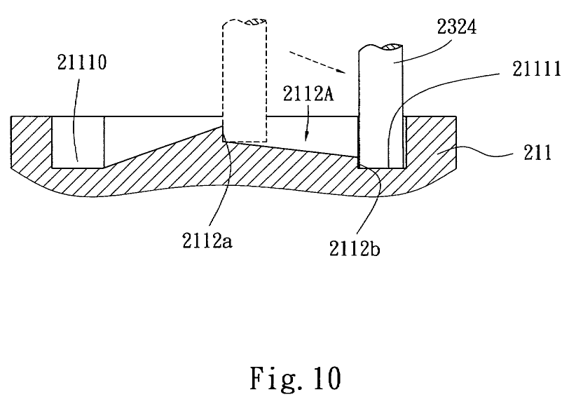

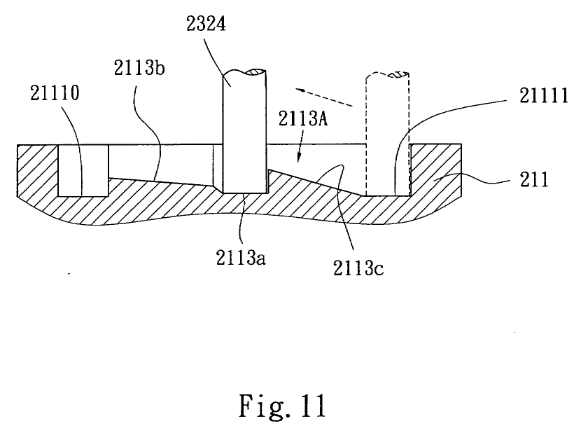

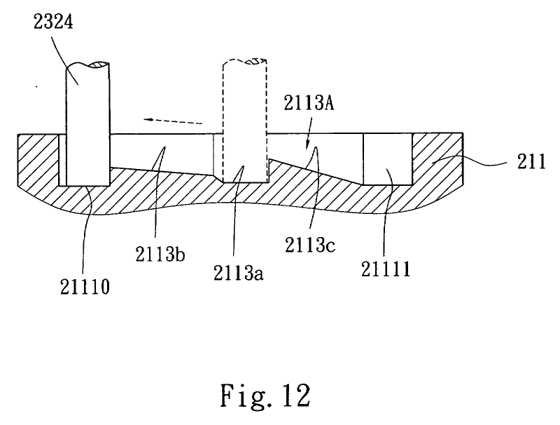

Referring to FIGS. 5 and 6, before or after viewing or trial fitting of the valuables 50, and the lock 30 is pulled out, also referring to FIG. 8, by pulling the wire reel 2116 the wire wheel 21 can be driven to rotate, the other end of the pin 2324 held in the 1-shaped groove 2112A and 7-shaped groove 2113A is moved outwards with the wire reel 2116 such that the other end of the pin 2324 is latched in the latch end 2112a of the 1-shaped groove 2112A (referring to FIG. 9). While the wire reel 2116 is pulled out the frame 14 of the upper lid 16 also can be turned for 360 degrees to facilitate extension or retraction of the lock 30 according to the location of the customers. When the wire reel 2116 is pulled again, the other end of the pin 2324 drops into the rear end 2113c of the 7-shaped groove 2113A and is moved gradually from a lower elevation to the higher middle portion 2113a and stops (referring to FIGS. 10 and 11), then is moved gradually lower to the front end 2113b to form a latched and anchored condition (referring to FIG. 12). Meanwhile the elastic element 22 is continuously retracted.

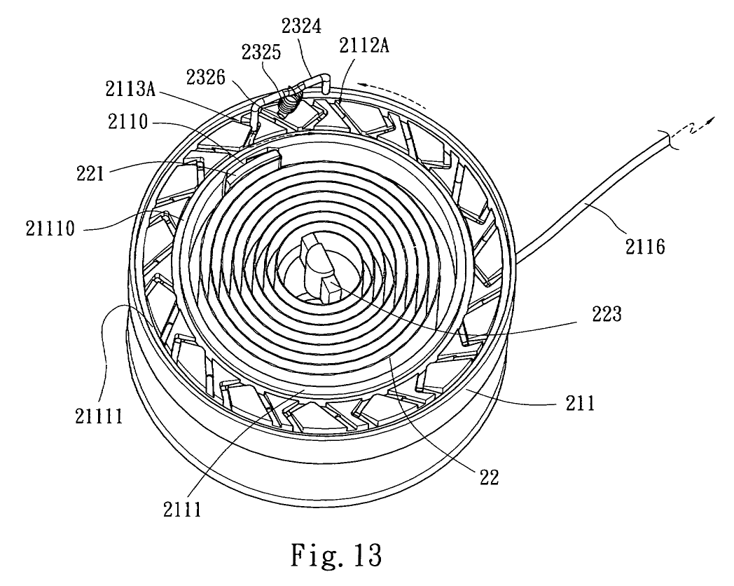

Referring to FIG. 13, to retract the wire reel 2116, first pull the wire reel 2116 to make the other end of the pin 2324 to slide downwards from the stationed middle portion 2113a of the 7-shaped groove 2113A to the front end 2113b, and slide and drop into the inner annular groove 21110 to be turned; then the wire reel 2116 can be wound. Meanwhile the retracted elastic element 22 is driven to extend again.

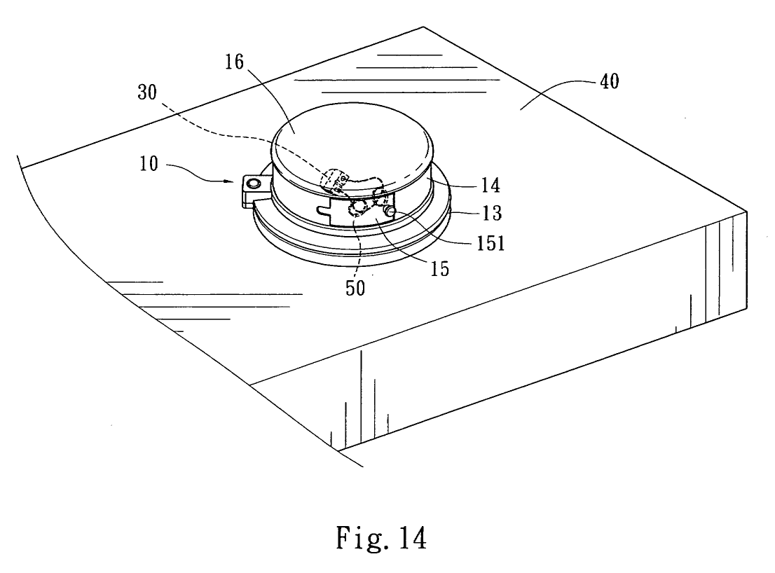

Referring to FIGS. 1 and 14, when the lock 30 is not in use, the one end of the lock 30 fastened to the wire reel 2116 can be retracted to the periphery of the boss 2112 of the wheel seat 211. Hence the lock 30 can be fully retracted and held in the wire winding box 10. The sliding door 15 may be closed by pushing the handle 151 so that the valuables 50 can be kept for next display. By means of the invention the risk of pilferage of the valuable 50 during viewing and trial fitting can be prevented.

What is claimed is:

1. A locking box for valuables, comprising at least:
a wire winding box which has a fastening seat consisting of an upper fastening disk and a lower fastening disk, a frame at an upper end of the fastening seat and an upper lid to cover an upper side of the frame, the frame being coupled on the fastening seat and having a notch on one side;
a winding control assembly which is hinged in the wire winding box and includes a wire wheel, an elastic element and a holding board; the wire wheel having a wheel seat which has a holding trough containing a latch trough and a boss at an upper end to wind a wire reel, the elastic element being held in the holding trough and having a latch member at one end running through the latch trough to be latched, the holding board being located on an upper side of the fastening seat and having an eccentric holding trough at a lower end to fasten the fastening seat and the upper fastening disk; and
a lock which is retractable in the frame and has an opening at one end to receive a detection terminal at other end of the wire reel, and a first and a second fastening holes at another end to receive a connection bar and a fastening end fastened to a threading wire.

2. The locking box for valuables of claim 1, wherein the fastening seat has an outer directing trough on the periphery of an upper end thereof to be wedged in by the frame and a bulging surface which has an opening in the center, the outer directing through and the bulging surface being interposed by a wedge trough, an inner directing trough and an arched notch, the fastening seat also having a lower end which has a housing space and a plurality of sunken holes.

3. The locking box for valuables of claim 1, wherein the upper fastening disk is located in a housing space of the fastening seat and has a strut in the center of an upper end thereof facing the opening of the bulging surface, the strut having a plurality of screw holes at an upper side and a plurality of apertures close to the periphery corresponding to the sunken holes of the fastening seat, a lock element on the periphery and a corresponding latch hole at a lower end thereof to be fastened by a fastening member.

4. The locking box for valuables of claim 1, wherein the lower fastening disk has a slot at a upper end which has a latch flange at one end and a latch lug on the periphery corresponding to a lock element of the upper fastening disk.

5. The locking box for valuables of claim 1, wherein the frame is hollow and has an arched edge at a lower end of an inner side of the notch and an arched directing trough above the arched edge, the arched directing trough holding a sliding door which has a handle.

6. The locking box for valuables of claim 1, wherein the upper lid has a lower end extending downwards to form a frame that has a plurality of screw holes on the periphery and a shaft which has a latch slot in the center and an arched trough at the edge of a lower end.

7. The locking box for valuables of claim 1, wherein the wheel seat has an inner annular groove and an outer annular groove at a bottom end that are interposed by 1-shaped grooves and 7-shaped grooves that are formed alternately.

8. The locking box for valuables of claim 7, wherein the 1-shaped groove has an inner side bent gradually from a lower elevation to a higher elevation to form a hook end and inclined gradually to form a latch end with the outer annular groove.

9. The locking box for valuables of claim 7, wherein the 7-shaped groove inclines gradually from a middle portion to a lower elevation towards two sides at a front end and a rear end which communicates with the outer annular groove.

10. The locking box for valuables of claim 1, wherein the boss of the wheel seat has a through hole running through the holding trough and a plurality of screw holes on the periphery, and a notch at one side to be latched by a hook end at one end of the wire reel and upper side fastened by a sealing cap which has an opening in the center and a plurality of apertures on the periphery.

11. The locking box for valuables of claim 1, wherein the holding board is located on an upper side of the fastening seat and has an arched groove on the periphery and an eccentric holding trough at a lower end, and an annular wedge member held in the fastening seat, the annular wedge member having a coupling element close to one side that has a conical cavity in the center and a corresponding through hole and a slot to hold a pin, the pin being coupled with a spring and pressed by a pressing bar to the bottom end of the conical cavity.

12. The locking box for valuables of claim 11, wherein the eccentric holding trough has fastening holes on the periphery and an eccentric frame at an upper end which has a center hole formed thereon, the eccentric frame having a holding trough to hold a plastic blade.
